(19) United States
(12) Patent Application Publication
(10) Pub. No.: US 2009/0106005 A1
(43) Pub. Date: Apr. 23, 2009

(54) SIMULATION REPRODUCING APPARATUS

(75) Inventor: Koichi Kondo, Kawasaki-shi (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/257,081

(22) Filed: Oct. 23, 2008

(30) Foreign Application Priority Data
Oct. 23, 2007 (JP) P2007-275270

(51) Int. Cl. G06G 7/48

(52) U.S. Cl. 703/7

(57) ABSTRACT

A simulation reproducing apparatus performs a simulation for verifying a control program for controlling a target mechanism of a mechatronics apparatus by simulating a behavior of the target mechanism in cooperation with the control program by performing a dynamics simulation and a kinetics simulation over a given cycle times.

### RELATED APPLICATION(S)

The present disclosure relates to the subject matters contained in Japanese Patent Application No. 2007-275270 filed on Oct. 23, 2007, which are incorporated herein by reference in its entirety.

### FIELD

The present invention relates to an apparatus, a method and a program for performing a simulation and displaying a progress of the simulation, in a simulation system for verifying a control program of a target mechanism of a mechatronics apparatus, by using a simulator for simulating a behavior of the target mechanism in cooperation with the control program.

### BACKGROUND

Conventionally, there has been known a method for creating an assembly model of a plurality of components having two-dimensional or three-dimensional shapes by utilizing a computer aided design system (CAD system). The conventional method for creating assembly model includes steps of: inputting shape data for each of a plurality of components by using the CAD system; defining geometric constraints, such as parallel, perpendicular, coincidence, a distance, an angle or concentric, between geometric features of the components which are referred to as shape features; and automatically calculating a positional relationship between the components by computer software based on the shape data (the geometric features) and the constraints, thereby creating the assembly model. Furthermore, there has been known a method for performing a mechanical analysis on the mechanism by inputting into the assembly model a portion having a degree of freedom as a joint, and by performing a simulation of a motion of the mechanism by changing a mechanical parameter (for example, a joint angle).

There has been known a software off-line programming system for a robot for defining a movement of the robot through a computer simulation and for considering a positional relationship of the robot and a belt conveyer in a production line without preparing an actual robot on an installation site.

There has been known a simulation system for a mechatronics apparatus for verifying a control program by using a simulator in place of an actual mechanism to be a control target. The simulation system performs a simulation by executing a simulator of the mechatronics apparatus in cooperation with a control program for controlling the simulator, and thereafter, the simulation system displays a status of the simulation. In the case in which a result different from a behavior assumed in the beginning is obtained, it can be assumed that the control program has errors so that it is necessary to debug the control program. In a process for debugging or correcting the control program, it is very advantageous to display the status of the simulation in any optional time when specifying a cause of a problem. Considering a volume of data, it is possible to totally store both the details of a command transmitted from the control program and a timing at which the command is transmit. However, it is not practical to store history of every calculation result for position and posture of each of the components, because the target mechanism has a large amount of components and those components intricately operate in relation with one another. In order to specify the positions and postures of the components in a three-dimensional space, a matrix of 4×4 is usually required, and it is not practical to store the history for all of the components regarding positions and postures for every control cycle time that is finely divided. Therefore, a command sequence transmitted from the control program (for example, a command value of a position of a motor) is utilized to calculate and display a status of the target mechanism at a time point that a reproduction is to be performed.

Conventionally, there has been known a technique for creating an assembly model which can be used for a mechanism analysis or an obstacle avoiding operation planning. An example of such technique is disclosed in Japanese Patent No. 3643504.

As for a simulation using a hybrid model, there has been known a simulation method applied to a linked simulation with control software for modeling a complicated mechanism system easily and accurately by using the hybrid model and controlling the mechanism system. An example of such technique is disclosed in JP-A-2004-178300 (counterpart U.S. publication is: US 2004/0158442 A1).

There has been proposed a technique utilizing a hybrid modeling language for testing and debugging control software. An example of such technique is disclosed in the following related-art document 1.

There has also been proposed a technique for verifying a control board for a massage chair including an operation thereof before completing a final mechanical design of the massage chair. An example of such technique is disclosed in the following related-art document 2.

Related-art document 1: “Use of Hybrid Models for Testing and Debugging Control Software for Electromechanical Systems,” IEEE/ASME Trans. Mechatronics, Vol. 10, No. 3, June 2005, pp.275-284

Related-art document 2: KONDO Koichi, HOSHINO Susumu, MOTOHASHI Shoichi: “Simulation-Based Process Innovation of Firmware Development for Electromechanical Products,” Toshiba Review, Vol. 60, No. 1, 2005

However, when a simulation result is to be reproduced and displayed, it is required to display the status of the simulation at an optional time that is randomly selected by a user. Therefore, even if a rotating angle of a shaft of a motor is determined, for example, it is impossible to determine any of solutions of an equation describing a system in some cases, for example, there is a possibility that a link mechanism connected to the shaft might take one of a plurality of postures. For example, an example is assumed in which a robot having a wrist and a hand in a degree of freedom of a rotation with respect to the wrist approaches a stationary bar and the hand grasps the bar. A status in which the hand grasps the bar may be one of two types, that is, (1) a status in which the hand is moved toward the bar in a direction in which the hand approaches the bar and thus grasps the bar and (2) a status in which the hand passes a position of the bar and is turned back toward a direction the hand moved to grasp the bar. In this example, when the simulator solves the equation, it is possible to obtain respective solutions for the two types of states. However, it is impossible to determine whether which of the two solutions is to be selected.

The simulator stores an initial position, a position at the end of the simulation and a status in which a last reproduction and display is performed for each of the components included in the mechanism. When performing the simulation, the simulator recalculates the status of the mechanism at a small time interval. Therefore, it is possible to obtain a correct calculation result by selecting a solution in a status close to the status of the mechanism which is obtained in the last simulation. However, there is no such reference when reproducing and displaying the previous simulation result.

In order to eliminate this drawback, it is possible to propose a technique for the simulator to simulate the operation of a mechanism in order of a time history of a calculation result at each time points and to obtain a status of the mechanism at a time point at which a display is to be finally performed (a positional relationship in a three-dimensional space) without performing a transition to a status at a time point in which the display is to be actually performed after calculating the same status through the simulator. It can be supposed that the process of the simulator can be relieved through skipping a time interval of the execution of the simulation every several intervals when following the time history. However, there is a problem in that a large amount of a calculation is still required by using the technique.

### SUMMARY

According to a first aspect of the invention, there is provided a simulation reproducing apparatus that performs a simulation for verifying a control program for controlling a target mechanism of a mechatronics apparatus by simulating a behavior of the target mechanism in cooperation with the control program, the apparatus including: a hybrid model simulator that reads out hybrid model data describing a motion of a movable component included in the target mechanism and performs a dynamics simulation while reading a control command output from the control program for every cycle time during the dynamics simulation; an assembly model storing module that reads out mechanism model data and stores assembly model data for an assembly model represented by geometric features of components included in the target mechanism and by constraints between the components; a geometric constraint module that performs a geometric constraint process by referring to the assembly model data; a movement monitoring module that monitors the geometric constraint module to detect a movement of the components; a variable history storing module that stores data input to the geometric constraint module from the hybrid model simulator for every cycle time and a result of movement detected by the movement monitoring module; and an intermediate position determination module that calculates an intermediate position on which the geometric constraint module is to be started by referring to a current display time point and a desired simulation time point, the current display time point being currently displayed after completion of the simulation, the desired simulation time point being input after completion of the simulation for reproducing the result of the simulation thereat, wherein the geometric constraint module is started based on the intermediate position calculated by the intermediate position determination module to output the result of the geometric constraint process re-performed based on the intermediate position.

According to a second aspect of the invention, there is provided a method for performing a simulation for verifying a control program for controlling a target mechanism of a mechatronics apparatus by simulating a behavior of the target mechanism in cooperation with the control program, the method including: performing a simulation including a dynamics simulation and a kinematics simulation over a given cycle times, the dynamics simulation being performed by a hybrid model simulation module for performing the dynamics simulation by using a hybrid model describing a motion of a movable component included in the target mechanism, the kinematics simulation being performed by a kinematics simulation module for performing the kinematics simulation by using an assembly model represented by geometric features of components included in the target mechanism and by constraints between the components; reading out a desired simulation time point at which the result of the simulation is to be reproduced; fetching a current time point being currently displayed after completion of the simulation; calculating an intermediate position on which a geometric constraint process is to be performed based on the desired simulation time point and the current time point; re-performing the kinematics simulation including the geometric constraint process on the intermediate position by the kinematics simulation module; and outputting the result of the simulation at the desired simulation time point.

According to a third aspect of the invention, there is provided a computer readable medium storing a program causing a computer to execute a process for performing a simulation for verifying a control program for controlling a target mechanism of a mechatronics apparatus by simulating a behavior of the target mechanism in cooperation with the control program, the process including: performing a simulation including a dynamics simulation and a kinematics simulation over a given cycle times, the dynamics simulation being performed by a hybrid model simulation module for performing the dynamics simulation by using a hybrid model describing a motion of a movable component included in the target mechanism, the kinematics simulation being performed by a kinematics simulation module for performing the kinematics simulation by using an assembly model represented by geometric features of components included in the target mechanism and by constraints between the components; reading out a desired simulation time point at which the result of the simulation is to be reproduced; fetching a current time point being currently displayed after completion of the simulation; calculating an intermediate position on which a geometric constraint process is to be performed based on the desired simulation time point and the current time point; re-performing the kinematics simulation including the geometric constraint process on the intermediate position by the kinematics simulation module; and outputting the result of the simulation at the desired simulation time point.

According to a fourth aspect of the invention, there is provided a simulation reproducing apparatus that performs a simulation for verifying a control program for controlling a target mechanism of a mechatronics apparatus by simulating a behavior of the target mechanism in cooperation with the control program, the apparatus including: a memory that stores data; and a processor that operates in cooperation with the memory to: perform a simulation including a dynamics simulation and a kinematics simulation over a given cycle times, the dynamics simulation being performed by a hybrid model simulation module for performing the dynamics simulation by using a hybrid model describing a motion of a movable component included in the target mechanism, the kinematics simulation being performed by a kinematics simulation module for performing the kinematics simulation by using an assembly model represented by geometric features of components included in the target mechanism and by constraints between the components; read out a desired simulation time point at which the result of the simulation is to be reproduced; fetch a current time point being currently displayed after completion of the simulation; calculate an intermediate position on which a geometric constraint process is to be performed based on the desired simulation time point and the current time point; re-perform the kinematics simulation including the geometric constraint process on the intermediate position by the kinematics simulation module; and output the result of the simulation at the desired simulation time point.

According to a fifth aspect of the invention, there is provided a simulation reproducing apparatus that performs a simulation for verifying a control program for controlling a target mechanism of a mechatronics apparatus by simulating a behavior of the target mechanism in cooperation with the control program, the apparatus including: a hybrid model simulation means for reading out hybrid model data describing a motion of a movable component included in the target mechanism and performing a dynamics simulation while reading a control command output from the control program for every cycle time during the dynamics simulation; an assembly model storing means for reading out mechanism model data and storing assembly model data for an assembly model represented by geometric features of components included in the target mechanism and by constraints between the components; a geometric constraint means for performing a geometric constraint process by referring to the assembly model data; a movement monitoring means for monitoring the geometric constraint means to detect a movement of the components; a variable history storing means for storing data input to the geometric constraint means from the hybrid model simulation means for every cycle time and a result of movement detected by the movement monitoring means; and an intermediate position determination means for calculating an intermediate position on which the geometric constraint means is to be started by referring to a current display time point and a desired simulation time point, the current display time point being currently displayed after completion of the simulation, the desired simulation time point being input after completion of the simulation for reproducing the result of the simulation thereat, wherein the geometric constraint means is started based on the intermediate position calculated by the intermediate position determination means to output the result of the geometric constraint process re-performed based on the intermediate position.

### BRIEF DESCRIPTION OF THE DRAWINGS

In the accompanying drawings:

FIG. 1 is a view showing an example of a simulation system having a simulation reproducing apparatus according to an embodiment of the invention;

FIG. 2 is a drawing showing an overall configuration of the simulation system for verifying a control program by use of a simulator;

FIG. 3 is a drawing showing, in detail, an internal configuration of the simulation reproducing apparatus according to the embodiment of the invention;

FIG. 4 is a view for explaining a geometric constraint condition;

FIG. 5 is a drawing showing a status in which geometric features of each component and a constraints defined between the geometric features are stored in a storage device when an assembly model is to be created;

FIG. 6 is a view for explaining a method of representing a geometric constraint as an algebraic equation in a two-dimensional model in a processor;

FIG. 7 is a view for explaining a degree of freedom;

FIG. 8 is a view for explaining a geometric constraint condition which is newly defined within a range in which the degree of freedom exists;

FIG. 9 is a drawing showing a status in which geometric features of each component, constraints between the geometric features and constraints introduced for defining a actuator part such as a joint are stored in the storage device;

FIG. 10 is a view showing a status at a first time point of a mechanism configured by a plurality of components, each of which can take a plurality of positions and postures;

FIG. 11 is a view showing a status at a second time point of the mechanism configured by the components, each of which can take the positions and postures;

FIG. 12 is a view showing a status at a third time point of the mechanism configured by the components, each of which can take the positions and postures;

FIG. 13 is a view showing a status at a first time point of a mechanism requiring a convergence calculation;

FIG. 14 is a view showing a status at a second time point of the mechanism requiring the convergence calculation;

FIG. 15 is a view showing a status at a third time point of the mechanism requiring the convergence calculation;

FIG. 16 is a view showing a first example of a status of a mechanism in which a link is connected to a follower shown in FIG. 13;

FIG. 17 is a drawing for explaining order for determining a position of the component;

FIG. 18 is a view showing a second example of the status in which the link is connected to the follower shown in FIG. 13;

FIG. 19 is a flowchart showing a process for determining whether intermediate position determination module is to calculate an intermediate position or not;

FIG. 20 is a chart showing an example of a simulation result of a DC motor model represented by a hybrid model;

FIG. 21 is a view for explaining a first status of a piston actuator and a differential equation corresponding thereto;

FIG. 22 is a view for explaining a second status of the piston actuator and a differential equation corresponding thereto;

FIG. 23 is a view for explaining a third status of the piston actuator and a differential equation corresponding thereto;

FIG. 24 is a view for explaining a fourth status of the piston actuator and a differential equation corresponding thereto;

FIG. 25 is a view for explaining a status transition of the piston actuator;

FIG. 26 is a view obtained by simplifying the status transition view of the piston actuator in FIG. 25; and

FIG. 27 is a drawing showing an example of a program of a hybrid constraint programming language corresponding to FIG. 26.

### DETAILED DESCRIPTION OF THE EMBODIMENTS

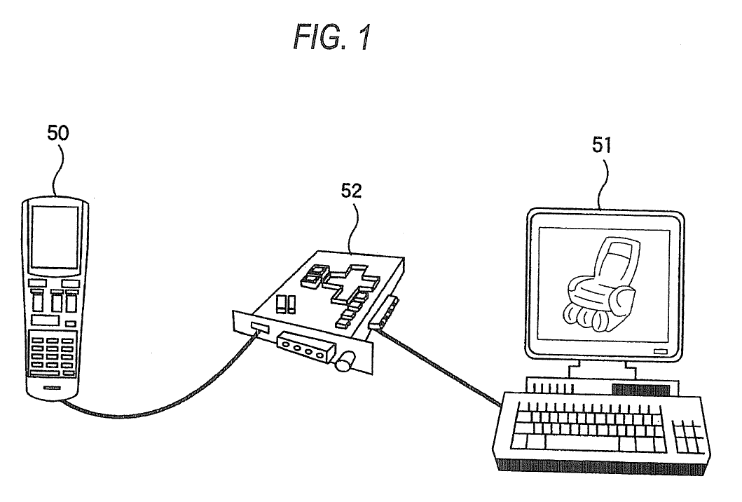

With reference to FIGS. 1 to 27, description will be given to a simulation reproducing apparatus, a method for reproducing a simulation result and a simulation program according to an embodiment of the invention. The same portions and components in each drawing are denoted by the same reference numerals and repetitive description will be omitted.

The simulation reproducing apparatus according to the embodiment of the present invention serves to verify a control program for controlling an actual electromechanical mechanism by performing a simulation using a simulator in place of the actual mechanism. FIG. 1 is a view showing an example of a simulation system using the simulation reproducing apparatus according to the embodiment. The simulation system includes a remote controller 50 for allowing a user to input an operating command, a control target simulator 51 for simulating an actual mechanism and reproduces and displays an operation of the actual mechanism by a three-dimensional graphics, and a control board 52 that serves as an interface of a signal between the remote controller 50 and the control target simulator 51.

In the example, it is assumed for developing and verifying control software for controlling a massage chair and details thereof have been described in the related-art document 2, which is previously referred to. A control software engineer provides an ROM storing software for controlling an actual mechanism (which will be referred to as firmware) on the control board 52 and connects the control board 52 to the control target simulator 51 in place of a connection to the massage chair as a control target. In the example, the software on the control board 52 is operated based on a manipulation of the remote controller 50 and a command is transmitted from the software to the control target simulator 51. A motion of the control target is displayed on a display device of the control target simulator 51 by using computer graphics.

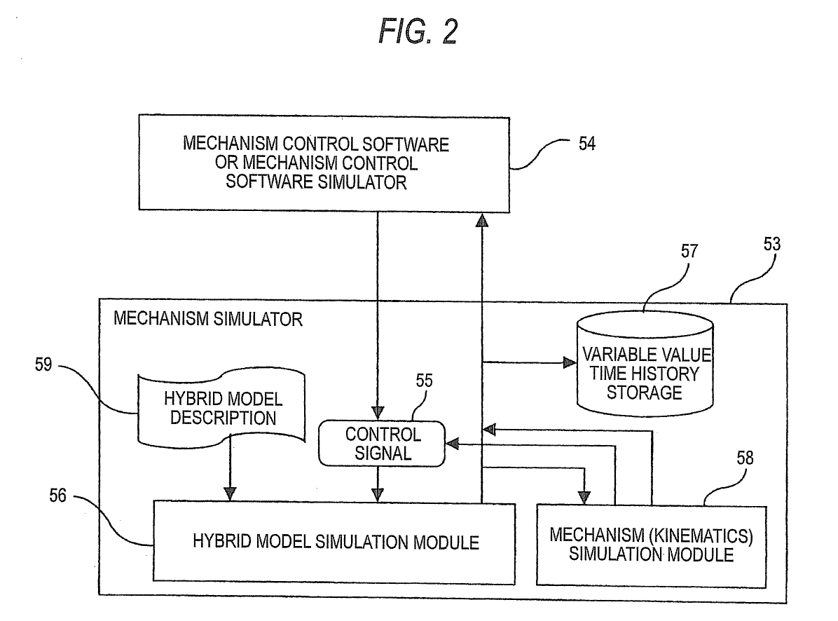

FIG. 2 is a drawing showing an overall configuration of a simulation system for verifying a control program by using a simulator in place of an actual mechanism to be a control target. The simulation system includes a mechanism simulator 53 for simulating the actual mechanism and a mechanism control software simulator 54 having mechanism control software. The mechanism simulator 53 serves as the simulation reproducing apparatus according to the embodiment and is provided on the control target simulator 51. The mechanism control software is mounted on the control board 52. The mechanism simulator 53 serves to calculate a position and a posture of the mechanism in a three-dimensional space at a given time and to display an assembly model on a display device, and is used for verifying which posture is taken by the mechanism when a rotating angle of a shaft of a motor is a predetermined angle, for example. The mechanism control software simulator 54 gives the mechanism simulator 53, as a control signal 55, an operating command to be sent to an actuator such as a motor or a solenoid which is a component of the mechanism to be the simulation target, for example. The operating command indicates a command for start and stop and a parameter of a value of a rotating speed of the motor shaft.

The mechanism simulator 53 includes a hybrid model simulation module (a hybrid model simulator) 56 having the function for expressing a dynamic characteristic of the motor and expressing a relationship between an elapsed time and a rotating angle of the motor shaft or a rotating speed thereof to perform a simulation, variable history storing module (a variable value time history storage) 57 for storing data of a movable component which are input from the hybrid model simulation module 56 every time step as a result of the simulation and a history of presence of a movement of a component, and a kinematics simulation module (a mechanism simulation module) 58 for calculating a position and a posture of each component from data such as the rotating angle of the motor shaft which are transmitted from the hybrid model simulation module 56. The hybrid model simulation module 56 serves to execute a dynamics simulation every cycle time based on a source program 59 describing the hybrid model of the mechanism and a command or a parameter included in the control signal 55 and to transmit data on a position or a posture of a movable component, for example, the rotating angle of the motor shaft to the mechanism control software of the mechanism control software simulator 54.

As an example, the hybrid model simulation module 56 performs syntax analysis on the source program 59 and thoroughly extracts in advance a description of a continuous system equation and that of control information about a status transition with an event before an execution of the simulation to separate the description of the continuous system and the description of the control information. The hybrid model simulation module 56 relates a conditional expression to an ID of the continuous system equation formed when the conditional expression is established and an ID of the continuous system equation which becomes invalid in relation to the ID of the continuous system equation based on the description of the control information about the status transition which is separated. The hybrid model simulation module 56 then stores the conditional equation and the IDs in a table, which is not shown. The hybrid model simulation module 56 converts the description into a simulation executable data structure and stores the data structure thus converted as internal data based on a result of the syntax analysis of the description of the continuous system equation which is separated. Upon receipt of the control signal 55, the hybrid model simulation module 56 determines a necessity of switching of the continuous system equation by referring to the table and switches the continuous system equation as appropriate. The hybrid model simulation module 56 performs a numerical integration by setting the internal data as a calculating target. The details of the hybrid model simulation will be described below.

In response to the above process, the hybrid model simulation module 56 performs a simulation operation to calculate the rotating angle of the motor shaft. The result is transmitted to the kinematics simulation module 58. In the kinematics simulation module 58, a positional relationship between components in a three-dimensional space of the mechanism is calculated based on a value of the obtained rotating angle. The positional relationship between the components is displayed on the display device as appropriate. The value of the rotating angle transmitted from the hybrid model simulation module 56 to the kinematics simulation module 58 is stored in the variable history storing module 57 in order to perform a reproduction after the completion of the simulation or to check a data value.

An angle sensor for detecting an angle formed between arms is attached to a joint portion of the mechanism to be the control target. The kinematics simulation module 58 also has the function to simulate a photosensor by preliminarily defining a light beam in a three-dimensional shape, thereby checking a geometric interference of the shape of the beam with other solid bodies. At each time step, the kinematics simulation module 58 can calculate the position and posture of the mechanism from the rotating angle of the motor shaft, thereby determining whether an arm of a robot intercepts the light beam of the photosensor or not at the mechanism simulator 53 side, for example. In other words, in the case in which a mechanism object having a complicated shape performs a motion in the three-dimensional space, the hybrid model simulation module 56 can efficiently calculate the angle detected by the angle sensor attached to the joint or a status such as the presence of the interference through the photosensor. Information about the angle and the status is transmitted to the mechanism control software simulator 54.

The mechanism simulator 53 and the mechanism control software simulator 54 are operated in cooperation with each other so that the mechanism control software simulator 54 can spuriously exchange, in a proper timing, the same data as data transferred to the mechanism of the actual mechanism together with the mechanism simulator 53. Thus, it is possible to implement verification software in a situation in which the actual mechanism is not present.

It is possible to configure the functions of the mechanism simulator 53 and the mechanism control software simulator 54 by using a general computer or a PC. The computer may include, as a basic hardware structure, a central process unit (CPU), a memory, an external storage device, a communication interface (I/F), a display device, and an input device such as a keyboard or a mouse which are not shown and mounts an operating system (OS) for controlling the hardware. The mechanism simulator 53 can be implemented as application software to be run on the operating system.

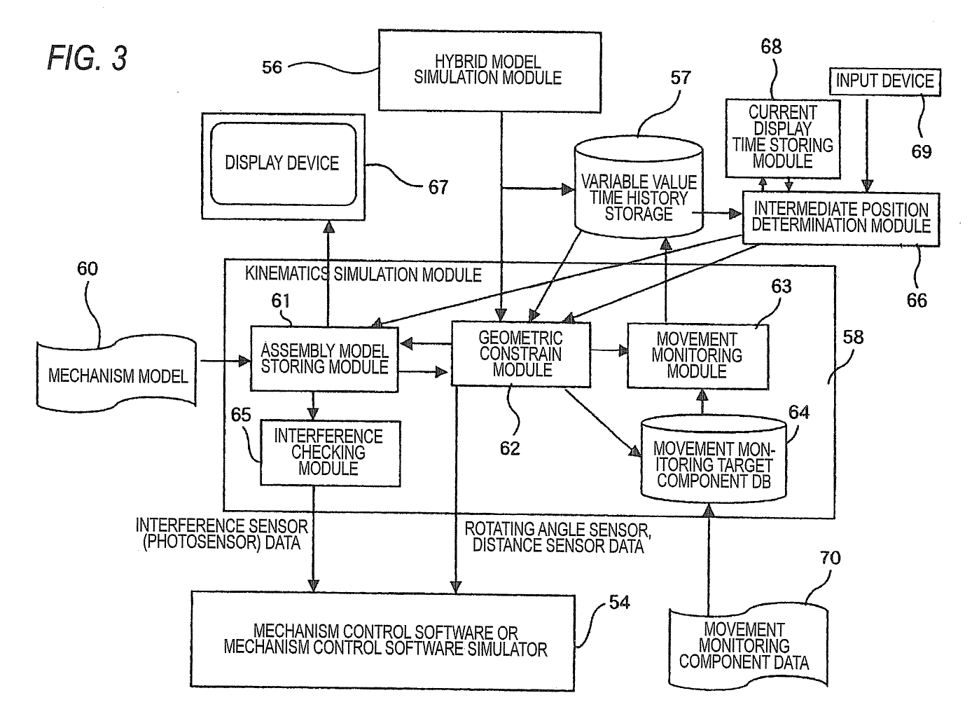

FIG. 3 is a drawing showing the internal configuration of the simulation reproducing apparatus according to the embodiment in more detail. The actual mechanism to be the control target is modeled as an assembly, which is an aggregate of components, by defining geometric features of a plane, such as a cylindrical surface or a sliding surface of a shaft in the component, and geometric constraints such as coaxiality or coincidence between the geometric features. The details of a method of describing and creating the assembly model will first be described.

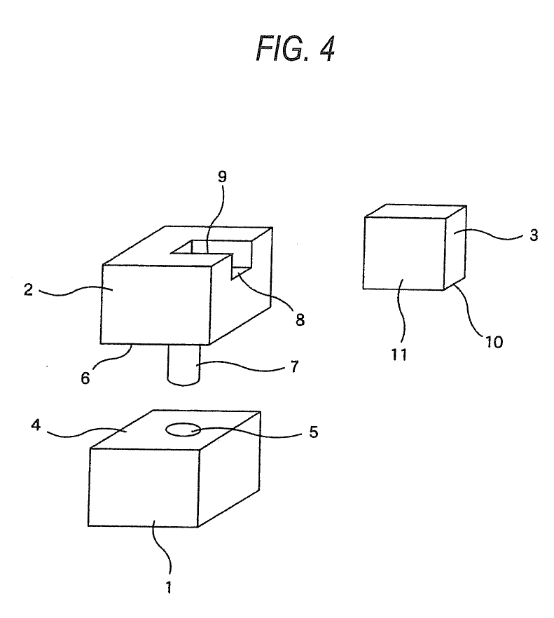

Although an example of the method of describing and creating an assembly model in the simulation reproducing apparatus according to the embodiment is described in Japanese Patent No. 3643504, a brief detail of perspective useful for explaining the simulation reproducing apparatus according to the embodiment will be described. FIG. 4 is a view for explaining a geometric constraint condition. The description will be given by taking, as an example, the case in which an assembly model configured by components 1, 2 and 3 shown in FIG. 4 is created. Each of shapes of the components 1, 2 and 3 shown in FIG. 4 is read from a file by using an input device of a computer and is stored in a storage device, for example. At this time, each component thus read is displayed on a screen of the display device as shown in FIG. 4, for example.

Next, in the case in which any of the relationships between the geometric features of the components is to be input, the geometric features and the relationship are input by using the input device and are stored in the storage device. For example, in order to create the assembly model from the components 1, 2 and 3 shown in FIG. 4, a relationship in which a plane 4 to be geometric features of the component 1 is coincident with a plane 6 to be geometric features of the component 2 and a cylindrical surface 5 to be the geometric features of the component 1 is coaxial with a cylindrical surface 7 to be the geometric features of the component 2 is input for the components 1 and 2. Similarly, a relationship in which a plane 8 to be the geometric features of the component 2 is coincident with a plane 10 to be geometric features of the component 3 and a relationship in which a plane 9 to be the geometric features of the component 2 is coincident with a plane 11 to be the geometric features of the component 3 are input for the components 2 and 3.

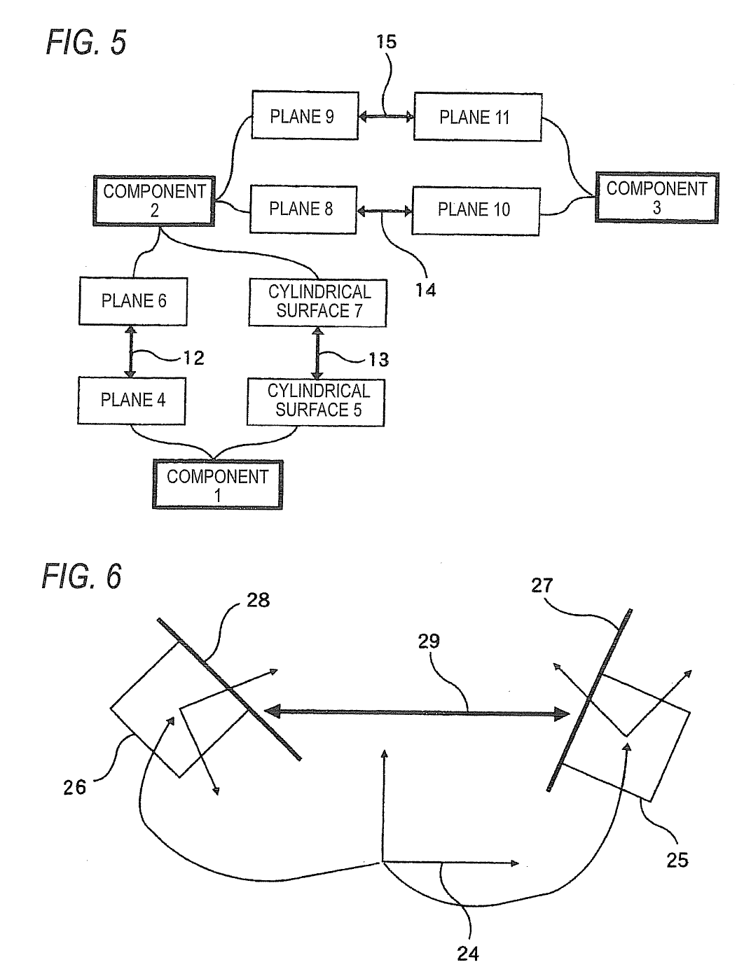

FIG. 5 shows an example typically illustrating, in the form of a graph, how to store the relationship thus input in the storage device. FIG. 5 is a typical drawing showing a status in which the geometric features of each component and a constraints defined between the geometric features are stored in the storage device when the assembly model is to be created. As is apparent from FIG. 5, in the storage device, coincident relationships 12, 14 and 15 of the planes and a coaxial relationship 13 of the cylinders are present as data in addition to information about the components 1, 2 and 3 and information about the geometric features.

Next, geometric constraint module 62 calculates a relative positional relationship between the components 1, 2 and 3 based on the information stored in the storage device. A function for calculating the relative positional relationship is generally provided in software and 3D-DCM, which is a product of D-Cubed Co., Ltd., England, is an example of the software, for example. The software will be hereinafter referred to as a geometric constraint library. More specifically, a local coordinate system which is peculiar to each component is set to the component and the relative positional relationship is expressed in the form of a transformation matrix between the local coordinate system and a global coordinate system fixed to a space in which an assembly model is to be created. In other words, a transformation matrix for expressing the position of the component 1 and that of each of the components 2 and 3 is automatically calculated through the geometric constraint library based on the relationships 12, 13, 14 and 15 between the components shown in FIG. 5. The geometric constraint module 62 in FIG. 3 can be implemented by using the geometric constraint library.

The contents of the process of the geometric constraint library will be described in more detail with reference to a simple two-dimensional example. FIG. 6 is a view for explaining a method of representing a geometric constraint as an algebraic equation in a two-dimensional model in a processor. As shown in FIG. 6, components 25 and 26 are present in a region indicated as a world coordinate system 24. It will be considered that a straight line 27 to be geometric features of the component 25 and a straight line 28 to be geometric features of the component 26 are caused to be coincident with each other based on a coincident relationship 29 and a position of the component 25 and that of the component 26 are thus calculated. The straight line 27 is expressed in a local coordinate system of the component 25 as shown in Equation (1).

a₁(x−x₁)+b₁(y−y₁)=0 (1)

The straight line 28 is expressed as shown in Equation (2) in a local coordinate system of the component 26.

a₂(x−x₂)+b₂(y−y₂)=0 (2)

A transformation matrix from a world coordinate system indicative of the position of the component 25 to the local coordinate system of the component 25 is as shown in Equation (3).

$$( \begin{matrix}cos {θ}_{1} & - sin {θ}_{1} & {α}_{1} \\ sin {θ}_{1} & cos {θ}_{1} & {β}_{1} \\ 0 & 0 & 1\end{matrix} ) \qquad ( 3 )$$

The transformation matrix from the world coordinate system to the component 26 is assumed to be as shown in Equation (4).

$$( \begin{matrix}cos {θ}_{2} & - sin {θ}_{2} & {α}_{2} \\ sin {θ}_{2} & cos {θ}_{2} & {β}_{2} \\ 0 & 0 & 1\end{matrix} ) \qquad ( 4 )$$

Assuming that an equation in a world coordinate system of the straight line 27 is set as shown in Equation (5) and an equation in a world coordinate system of the straight line 28 is set as shown in Equation (6), the relationship of the straight line 27 and the straight line 28 can be expressed by the following four simultaneous Equations (7)-(10)

$$\begin{matrix}{a}_{1 w} ( x - {x}_{1 w} ) + {b}_{1 w} ( y - {y}_{1 w} ) = 0 & ( 5 ) \\ {a}_{2 w} ( x - {x}_{2 w} ) + {b}_{2 w} ( y - {y}_{2 w} ) = 0 & ( 6 ) \\ ( \begin{matrix}{x}_{1 w} \\ {y}_{1 w} \\ 1\end{matrix} ) = ( \begin{matrix}cos {θ}_{1} & - sin {θ}_{2} & {α}_{1} \\ sin {θ}_{1} & cos {θ}_{1} & {β}_{1} \\ 0 & 0 & 1\end{matrix} ) ( \begin{matrix}{x}_{1} \\ {y}_{1} \\ 1\end{matrix} ) & ( 7 ) \\ ( \begin{matrix}{a}_{1 w} \\ {b}_{1 w}\end{matrix} ) = ( \begin{matrix}cos {θ}_{1} & - sin {θ}_{1} \\ sin {θ}_{1} & cos {θ}_{1}\end{matrix} ) ( \begin{matrix}{a}_{1} \\ {b}_{1}\end{matrix} ) & ( 8 ) \\ ( \begin{matrix}{x}_{2 w} \\ {y}_{2 w} \\ 1\end{matrix} ) = ( \begin{matrix}cos {θ}_{2} & - sin {θ}_{2} & {α}_{2} \\ sin {θ}_{2} & cos {θ}_{2} & {β}_{2} \\ 0 & 0 & 1\end{matrix} ) ( \begin{matrix}{x}_{2} \\ {y}_{2} \\ 1\end{matrix} ) & ( 9 ) \\ ( \begin{matrix}{a}_{2 w} \\ {b}_{2 w}\end{matrix} ) = ( \begin{matrix}cos {θ}_{2} & - sin {θ}_{2} \\ sin {θ}_{2} & cos {θ}_{2}\end{matrix} ) ( \begin{matrix}{a}_{2} \\ {b}_{2}\end{matrix} ) & ( 10 )\end{matrix}$$

On the other hand, a condition that two straight lines are coincident with each other is equivalent to two geometric conditions:

One point on one of the straight lines is present on the other straight line; and

Direction vectors are parallel with each other (a vector product of zero).

This is expressed in the world coordinate system as shown in Expression (11).

$$\{ \begin{matrix}{a}_{1 w} ( {x}_{2 w} - {x}_{1 w} ) + {b}_{1 w} ( {y}_{2 w} - {y}_{1 w} ) = 0 \\ {a}_{1 w} {b}_{2 w} - {b}_{1 w} {a}_{2 w} = 0\end{matrix} \qquad ( 11 )$$

By adding the condition to solve the simultaneous Equations (7)-(10), it is possible to calculate the positions of the components 25 and 26 which satisfy the condition that the straight lines 27 and 28 are coincident with each other. When sin θ and cos θ are represented by s and c respectively in order to solve the simultaneous Equations (7)-(10), the following six simultaneous Equations (12)-(17) are obtained. More specifically, the following quadratic simultaneous equations are obtained.

$$\begin{matrix}\{ \begin{matrix}{a}_{1 w} ( {x}_{2 w} - {x}_{1 w} ) + {b}_{1 w} ( {y}_{2 w} - {y}_{1 w} ) = 0 \\ {a}_{1 w} {b}_{2 w} - {b}_{1 w} {a}_{2 w} = 0\end{matrix} & ( 12 ) \\ ( \begin{matrix}{x}_{1 w} \\ {y}_{1 w} \\ 1\end{matrix} ) = ( \begin{matrix}{c}_{1} & - {s}_{1} & {α}_{1} \\ {s}_{1} & {c}_{1} & {β}_{1} \\ 0 & 0 & 1\end{matrix} ) ( \begin{matrix}{x}_{1} \\ {y}_{1} \\ 1\end{matrix} ) & ( 13 ) \\ ( \begin{matrix}{a}_{1 w} \\ {b}_{1 w}\end{matrix} ) = ( \begin{matrix}{c}_{1} & - {s}_{1} \\ {s}_{1} & {c}_{1}\end{matrix} ) ( \begin{matrix}{a}_{1} \\ {b}_{1}\end{matrix} ) & ( 14 ) \\ ( \begin{matrix}{x}_{2 w} \\ {y}_{2 w} \\ 1\end{matrix} ) = ( \begin{matrix}{c}_{2} & - {s}_{2} & {α}_{2} \\ {s}_{2} & {c}_{2} & {β}_{2} \\ 0 & 0 & 1\end{matrix} ) ( \begin{matrix}{x}_{2} \\ {y}_{2} \\ 1\end{matrix} ) & ( 15 ) \\ ( \begin{matrix}{a}_{2 w} \\ {b}_{2 w}\end{matrix} ) = ( \begin{matrix}{c}_{2} & - {s}_{2} \\ {s}_{2} & {c}_{2}\end{matrix} ) ( \begin{matrix}{a}_{2} \\ {b}_{2}\end{matrix} ) & ( 16 ) \\ \{ \begin{matrix}{c}_{1}^{2} + {s}_{1}^{2} = 1 \\ {c}_{2}^{2} + {s}_{2}^{2} = 1\end{matrix} & ( 17 )\end{matrix}$$

The equations have twelve independent expressions and include eight constants x1, y1, x2, y2, a1, b1, a2 and b2 representing equations of straight lines in the local coordinate systems of the straight lines 27 and 28. Sixteen variables are obtained and parameters c1, s1, c2, s2, α1, β1, α2 and β2 indicative of the positions of the components 25 and 26 are to be obtained. In order to obtain the values, it is preferable that the eight constants x1, y1, x2, y2, a1, b1, a2 and b2 and variables other than the parameters c1, s1, c2, s2, α1, β1, α2 and β2 indicative of the positions of the components 25 and 26 should be eliminated from the quadratic simultaneous equations to obtain values of c1, s1, c2, s2, α1, β1, α2 and β2. For a method of thus eliminating the variable, the Buchberger algorithm for obtaining the Groebner basis of a polynomial ideal has been known. Therefore, it is also possible to eliminate unnecessary variables and to then calculate the values of c1, s1, c2, s2, α1, β1, α2 and β2 by using the method or to substitute the constant of the quadratic simultaneous equations, thereby obtaining a solution directly. In any case, the number of the variables is larger than that of the equations by four. Therefore, it is apparent that the equation has a degree of freedom of four. The equation is defined in the global coordinate system. If it is noted that the attention is paid to the relative positional relationship between the two components, the position of one of the components may be fixed. Therefore, if c1, α1 and β1 are set to be constants on the assumption that the component 25 is fixed, for example, the number of the variables is larger than that of the equations by one. Consequently, it is apparent that the equation has a degree of relative freedom of one. In order to calculate the position of the component 26, it is preferable that one of the values of c2, s2, α2 and β2 should be determined as a constant (should be fixed to a current value) to obtain the other values. In general, in the case in which a constraint condition is defined in a situation in which the constraint condition cannot be implemented (for example, two straight lines are parallel with each other and are perpendicular to each other), a solution is not present in the simultaneous equations. Therefore, it is possible to detect that the constraint condition which cannot be implemented is given. Thus, the geometric constraint library represents the given constraints as an algebraic expression again and thus performs the process.

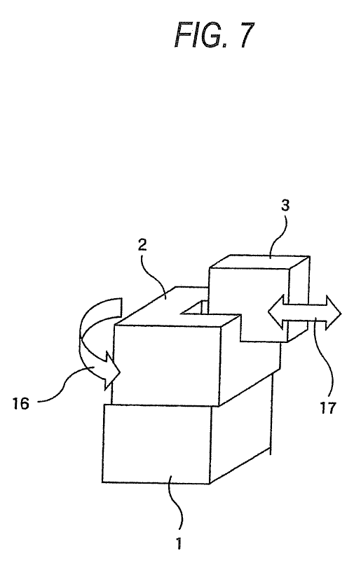

Referring back to FIG. 5, the description will further be given. FIG. 7 shows an example of a coincident relationship defined between the geometric features of the respective components, that is, a relative positional relationship (an assembly model) between the components which is calculated to satisfy all of the constraints between the geometric features. FIG. 7 is a view for explaining a degree of freedom. The relative positional relationship shown in FIG. 7 indicates the position of the component which is obtained by causing a transformation matrix of the component calculated automatically to act on shape data of the component.

As is apparent from FIG. 7, generally, the assembly model obtained as described above does not always have constraints for completely determining the relative positional relationship between the components. For example, even if a relative rotation 16 is performed between the components 1 and 2 and a parallel movement 17 is relatively performed between the components 2 and 3, all of the relationships shown in FIG. 5 are still maintained. More specifically, the assembly model shown in FIG. 7 has a rotation freedom degree 16 and a translation freedom degree 17.

On the other hand, in the field of a mechanism analysis, a motion is described through a parameter defining the degree of freedom of the mechanism. More specifically, in the example of FIG. 7, two parameters including a rotating angle corresponding to the rotation freedom degree 16 and a parallel moving distance corresponding to the translation freedom degree 17 correspond to the degree of freedom of the mechanism.

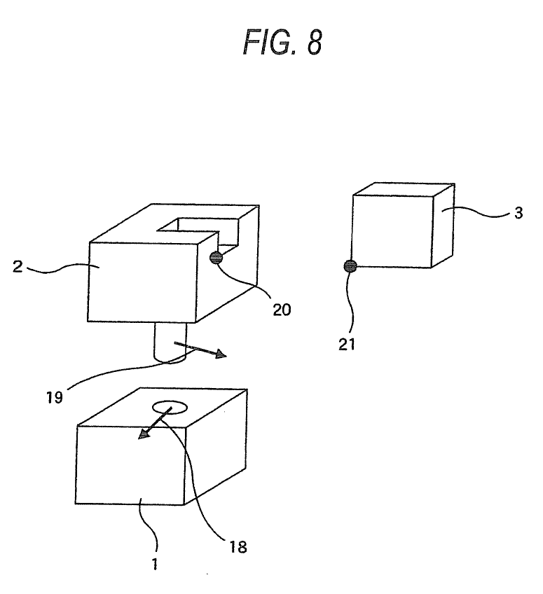

FIG. 8 is a view for explaining a geometric constraint condition defined newly within a range in which the degree of freedom exists. The reference numerals 18 and 19 denote a straight line representing a directional vector which is orthogonal to a central axis of a cylindrical surface. It is assumed that the straight lines 18 and 19 are rigidly connected to the cylindrical surfaces. If there is any constraints in which cylinders are coaxial with each other, angles of the straight lines 18 and 19 are added as a new constraints so that the angles act as parameters of the rotation freedom degree. Accordingly, the straight lines 18 and 19 are elements representing a shape or a position and posture of the cylinder. Therefore, the straight lines 18 and 19 are defined as geometric features in the simulation reproducing apparatus according to the embodiment.

In FIG. 8, the reference numerals 20 and 21 denote apexes on the components 2 and 3. Although the apexes 20 and 21 are not geometric features of planes for which constraints for coincident planes have already been defined, they are geometric elements on the planes and are related to each other geometrically or topologically. For this reason, a distance between the apexes 20 and 21 on the same straight line over the respective planes is added as a new constraints and thus serves as a parameter of the translation freedom degree in a constraints in which the plane 8 of the component 2 and the plane 10 of the component 3 are coincident with each other.

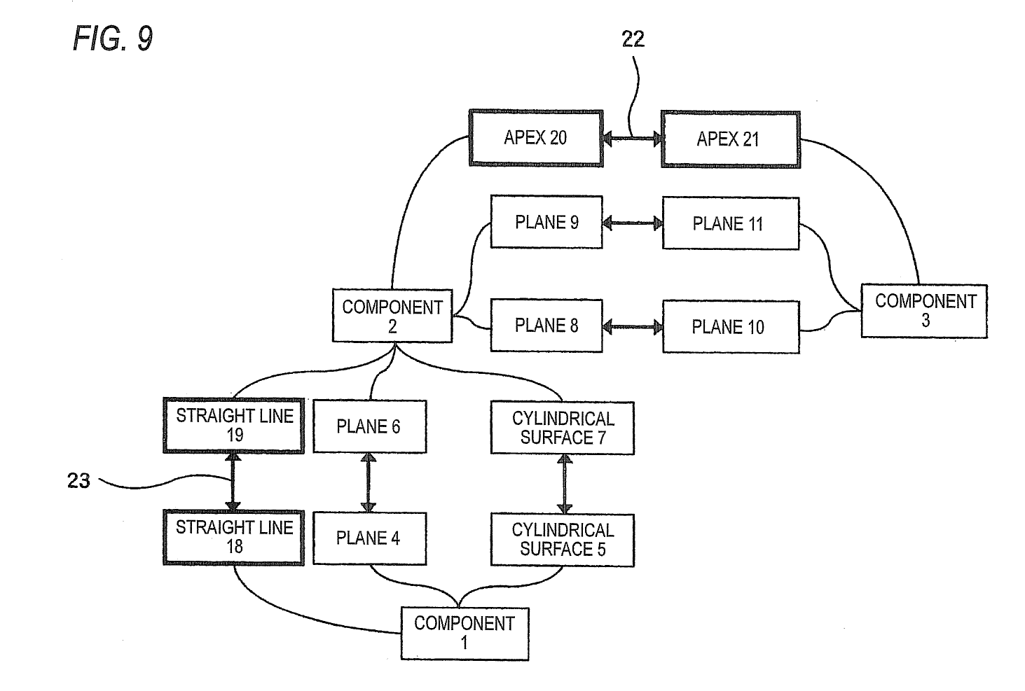

FIG. 9 shows a status in which the angles formed by the straight lines 18 and 19 and the distance between the apexes 20 and 21 shown in FIG. 8 are added as new constraints 22 and 23 to the assembly model illustrated in FIG. 5 and are stored in the storage device at that time. FIG. 9 is a drawing showing a status in which the geometric features of each component, a constraints between the geometric features and a constraints introduced for defining a actuator part such as a joint are stored in the storage device. In the case in which the degree of freedom exists between the components as shown in FIG. 5, a new constraint may be added between the components.

When the mechanism analysis is to be performed, it is also possible to perform intact, in the following manner, a simple mechanism analysis for causing the angles formed by the straight lines 18 and 19 and the distance between the apexes 20 and 21 shown in FIG. 8 to correspond to an actuator such as a motor, thereby obtaining a motion of the mechanism from a change in an actuator parameter (a rotating angle of the motor shaft). More specifically, when a value at a certain time for the mechanical parameter determined through the steps is given, positions and postures in a three-dimensional or two-dimensional space of the individual components are determined through the geometric constraint library. It is possible to perform verification of the motion of the mechanism through the simulation while sequentially changing the positions and the postures for every time interval. In FIGS. 2 and 3, a value transmitted from the hybrid model simulation module 56 to the geometric constraint module 62 indicates the angle of the motor.

In the case in which two rotating shafts are coupled to each other through a gear, it is preferable that a relationship between angle parameters such as the angles formed by the straight lines 18 and 19 shown in FIG. 8 should be represented as a primary expression in which a gear ratio of the gear is set to be a coefficient. More specifically, a mechanism such as the gear can be expressed in a polynomial. Therefore, the geometric constraint library can uniformly perform a process and a calculation by the same method as a method of representing and treating a given constraints as an algebraic expression. More specifically, it is sufficient that the primary expression setting the gear ratio as the coefficient is added to simultaneous equations. By using the same technique as a technique utilized for calculating the degree of freedom between solid bodies, it is also possible to calculate a whole decrease in the degree of freedom by one through an addition of the gear.

According to the assembly model creating method, the control target simulator 51 can represent a model of a delivering mechanism of a manufacturing apparatus or a mechanism of a robot, for example, and can simulate a geometric motion thereof. Mechanism model data 60 in FIG. 3 are created by the assembly model creating method.

Based on the description, the structure of FIG. 3 will be explained again. Elements having the same reference numerals in FIG. 3 as those described in FIG. 2 represent the same elements. The kinematics simulation module 58 includes assembly model storing module 61 for storing data of an assembly model, geometric constraint module 62 for calculating a geometric constraint condition of a component by using data of a movable component to be changed every time step such as a rotating angle of the motor shaft and data of the assembly model, movement monitoring module 63 for detecting presence of a movement of the component by referring to the geometric constraint condition, a movement monitoring target component database 64 for storing a component ID for performing monitoring through the movement monitoring module 63, and interference checking module 65 for checking an interference between the component and the solid body.

The mechanism simulator 53 has an intermediate position determination module 66 for calculating an intermediate position in which the geometric constraint module 62 is to be additionally started by referring to a time of a simulation to be reproduced and displayed which is input after the execution of the simulation and a current display time which has already been displayed, a display device 67 for displaying the contents of the simulation, a current display time storing module 68 for storing the current display time after the execution of the simulation, and an input device 69 for inputting a desirable simulation display time to the intermediate position determination module 66.

The geometric constraint module 62 is started based on a result of a calculation which is obtained by the intermediate position determination module 66 and the display device 67 displays the recalculated simulation result. The intermediate position determination module 66 writes a reproduction and display time as a current display time to the current display time storing module 68 after the display is completed.

The mechanism model data 60 are read before starting the simulation, and mechanism model data on a mechanism model of the control target are stored in the assembly model storing module 61. The geometric constraint module 62 calculates a position and a posture of a component in a model described in the assembly model based on the rotating angle of the motor shaft which is transmitted from the hybrid model simulation module 56. A shape model of the component is subjected to a movement process based on information about the position and the posture of the component which are calculated by the geometric constraint module 62, and the interference checking module 65 is started corresponding to a process such as an On/Off check of a photosensor if necessary. The interference checking module 65 transmits a status of the sensor as data to the mechanism control software simulator 54.

The geometric constraint module 62 calculates the position and the posture of the component each time the geometric constraint module 62 is started by the hybrid model simulation module 56. The geometric constraint module 62 can check whether or not the component is moved with respect to a status set one step before in the calculation. Also in the case in which a request for calculating the position and the posture of the component is given many times from the hybrid model simulation module 56, an identification may be performed on the assumption that any change is not made at the time intervals when a reproduction and a display are to be performed after the execution of the simulation if the component is not moved during that time. In the simulation reproducing apparatus according to the embodiment, the movement monitoring module 63 obtains information about presence of the movement of the component from the geometric constraint module 62, thereby checking the presence of the movement. However, in the reproduction and display of the simulation, it is not always necessary to check the movements of all the components in detail. It is not necessary to store the presence of the movement for the component which cannot be referred to. Therefore, the simulation reproducing apparatus according to the embodiment reads a movement monitoring component data file 70 before the execution of the simulation and stores an ID number of the component which is required for monitoring in the movement monitoring target component DB (movement monitoring target component database) 64, and the geometric constraint module 62 checks the presence of the movement for only the components registered therein.

The geometric constraint module 62 treats a relationship of the mechanism as the algebraic simultaneous equations as described above. Therefore, in a situation in which the geometric constraint module 62 is started by the hybrid model simulation module 56, it is possible to check whether the algebraic simultaneous equations have only one solution or a plurality of solutions for variables related to the respective components. For example, 3D-DCM by D-Cubed Co., Ltd., England, which is the geometric constraint library, can make an inquiry about the number of solutions of the position and posture every component. If the variable related to the component has only one solution, a unique solution is always obtained even if a calculation is performed in a completely different preliminary situation in the reproduction of the simulation. For this reason, it is not necessary to obtain the positional relationship between the components based on a continuity or a degree of approximation to situations therebefore and thereafter. Accordingly, the movement monitoring module 63 is configured to obtain, from the geometric constraint module 62, information about whether a plurality of positions and postures of the component is present or not. When the movement monitoring module 63 stores data indicative of the presence of the movement in the variable history storing module 57, information about the presence of the movement of the component which is obtained in the movement monitoring module 63 and information indicating whether the component having a plurality of positions and postures is present are stored together. Since both of the information are data indicative of only the presence of the movement, they are very small for a storage capacity.

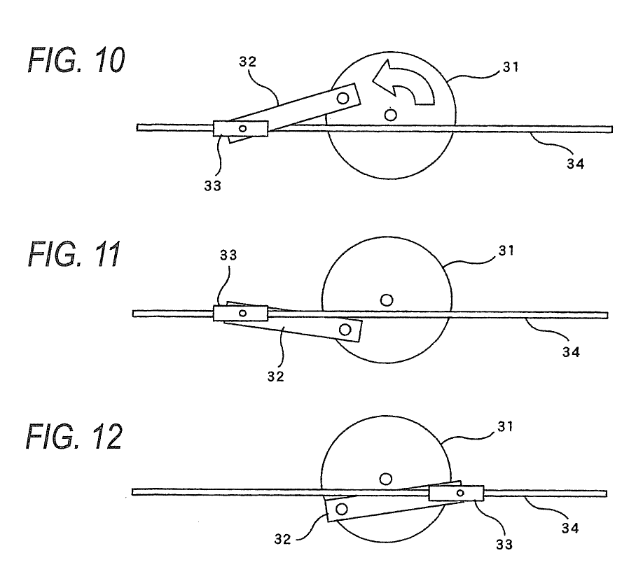

Referring to the case in which the component may take a plurality of positions and postures as described above, more specific description will be given by using a mechanism for performing the same motion as a reciprocation of a piston as an example of the mechanism. FIG. 10 is a view showing a status at a first point of a mechanism including four components, each of which can take a plurality of positions and postures. The mechanism shown in FIG. 10 serves to convert a rotational motion performed by a disk into a reciprocating linear motion of a slider attached to a guide rail. The mechanism includes a disk 31 for performing a rotational motion, a guiding rail 34 provided horizontally, a slider 33 attached to the rail 34 so as to enable a reciprocating linear motion between a first position and a second position in the rail 34, and a rod 32 for converting the rotational motion performed by the disk 31 into a linear motion of the slider 33. FIGS. 11 and 12 show a status brought after the disk 31 is rotated in the status of FIG. 10. FIG. 11 is a view showing a status at a second point of the mechanism and FIG. 12 is a view showing a status at a third point of the mechanism.

A shaft of a motor which is not shown is fitted into a central axis of the disk 31. The shaft is driven in accordance with a control command sent from the mechanism control software simulator 54. The disk 31 is coupled to one of ends of the rod 32 through a pin and the other end of the rod 32 is coupled to the slider 33 through a pin. The slider 33 is slides over the rail 34 and can be moved along the rail 34. The coupling of the pin is represented as geometric features, a coaxiality of cylinders for a geometric constraint and a coincidence of straight lines in the slider portion. More specifically, an outer peripheral surface of the pin, an internal wall of a through hole formed on the other end of the rod 32 and an internal wall of a through hole formed on the slider 33 are coaxial with each other so that the coaxiality of the cylinders is represented. The slider portion is represented by a coincidence of a straight line along the rail 34 with a straight line on the slider 33.

Assuming that the motor starts to drive the disk 31 at the status shown in FIG. 10 so that the disk 31 is rotated in a direction of an arrow in FIG. 10, it is expected that the status shown in FIG. 11 is brought after the disk 31 is slightly rotated. However, if a determination is made based on only a relationship of the pin coupling and a relationship between the rail 34 and the slider 33, a position shown in FIG. 12 is also correct as a solution of a continuous system equation describing a behavior of the mechanism. The simulation is executed while the motion is cut into fine time steps. There is selected a position of each of the components, that is, the disk 31, the rod 32 or the slider 33 at each point which is close to a last step. Therefore, in the case in which the cut into the steps is performed with the passage of time, the status shown in FIG. 12 is not obtained. However, in the case in which the status of FIG. 10 is changed into that of FIG. 12 at a time, for example, a difference in an angle formed by a center line in a longitudinal direction of the rod 32 and the rail 34 between the status of FIG. 10 and that of FIG. 12 is smaller than the difference in the angle between the status of FIG. 10 and that of FIG. 11. For this reason, there is a possibility that the status of FIG. 12 might be selected as the solution of the continuous system equation. As described above, the mechanism is internally represented with a conversion into an algebraic equation. A solution representing the status of the mechanism is obtained by solving the equation. Therefore, the values of the solutions of the equations which are close to each other are not always close to a human intuition in an actual mechanism in some cases. Thus, in the case in which at least two positions and postures are present (in this case, the geometric constraint module 62 specifies that at least two solutions are present for the rod 32 and the slider 33), it is possible to prevent an erroneous solution shown in FIG. 12 from being obtained by bringing the status of FIG. 11 via several points in an intermediate position between the position of FIG. 10 and the position of FIG. 12 when the system is moved to the status of FIG. 11 after the reproduction of the status of FIG. 10.

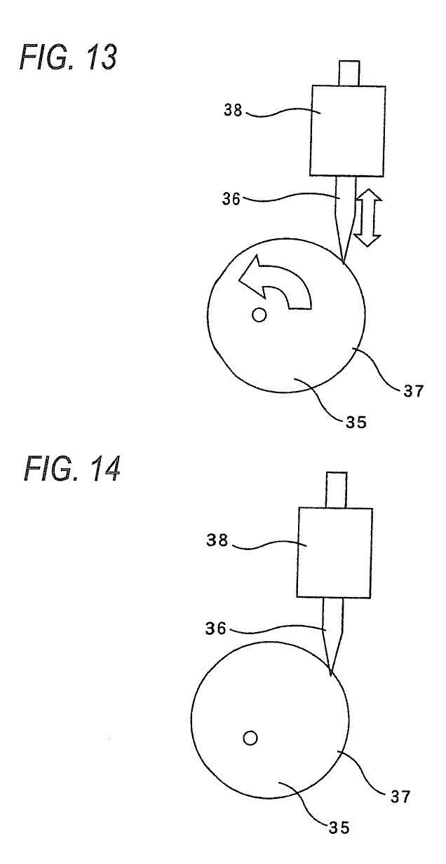

FIG. 13 is a view showing a status brought at a certain point of a mechanism which requires a convergence calculation. FIG. 13 shows an example of a mechanism configured by a cam 35 and a follower 36. The shaft of the motor is axially inserted into an eccentric axis positioned eccentrically from a center of the cam 35, and the motor is driven in accordance with the control command 55 sent from the mechanism control software simulator 54. A cam contour 37 is represented as a free-form surface to be a B-spline surface, and a geometric constraint is represented in such a manner that a tip point of the follower 36 is present on the cam contour 37. The follower 36 is held by a guide 38, and the follower 36 is controlled to be moved only vertically. When the eccentric axis of the cam 35 is rotated, the cam contour 37 is also moved so that the follower 36 is moved in a following manner. However, since the cam contour 37 is represented as the free-form surface, it cannot be expressed as an algebraic equation in the geometric constraint module 62 and the position of the follower 36 is obtained through the convergence calculation.

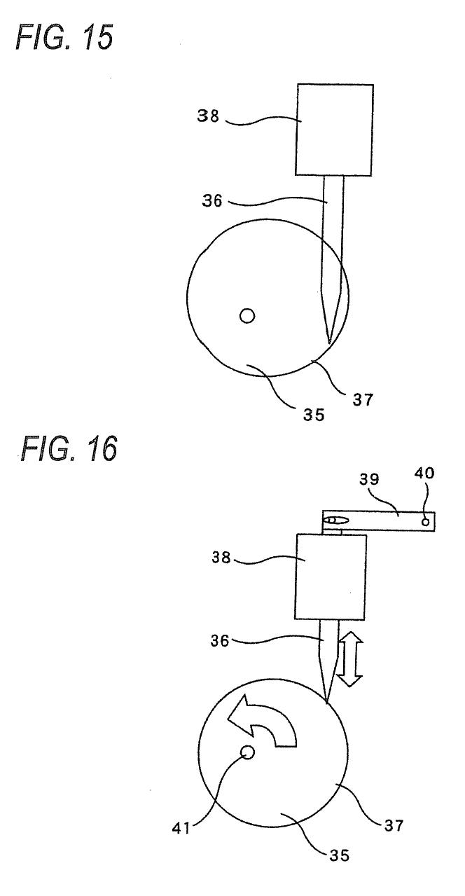

In the case in which the convergence calculation is performed, a solution to be obtained is varied depending on how to take an initial value. The simulation is executed while the motion is cut into fine time steps. For the initial values of the convergence calculation at the respective points, a value in a last step is used. Therefore, an erroneous result can be prevented from being obtained but a result shown in FIG. 14 is acquired, for example. However, in the case in which there is performed a rapidly great change from the status of FIG. 13 to that of FIG. 14, there is a danger that an erroneous result might be obtained by the calculation as in a status of FIG. 15. In the case in which a position calculation for the component is thus performed through the convergence calculation, it is impossible to analyze an algebraic equation and to previously determine whether there is a plurality of solutions of an equation describing the mechanism or not. The simulation reproducing apparatus according to the embodiment properly performs a calculation for an intermediate position between a moving start position and a moving end position via several points in the intermediate position corresponding to a degree of the movement, thereby obtaining the status of FIG. 14 when the component such as the cam 35 is provided and is moved. For this reason, it is desirable that the component requiring the convergence calculation for a locus, for example, the cam 35 should be registered in the movement monitoring target component DB 64. Which component requires the convergence calculation is not always apparent to a user. Therefore, it is desirable to set a method of displaying a list of the component on a screen of the display device 67, causing the user to select the required component and registering the selected component in the movement monitoring target component DB 64. Also in the case in which the convergence calculation is required, it is also possible to calculate all solutions by setting the initial value to a large number of different values and to determine whether the number of the solution is two or more through a calculation for obtaining the solution. By performing the process, it is also possible to treat the convergence calculation in the same manner as a calculation for a mechanism to perform the same motion as the reciprocation of the piston in FIG. 10.

The component over which the position calculation is to be executed through the convergence calculation is not restricted to the cam 35 and the follower 36. FIG. 16 is a view showing a status of a mechanism in which a link 38 is further connected to the follower 36 in FIG. 13. The link 39 has a slot for slidably inserting a pin therethrough at one of ends, and the end is coupled to an upper end of the follower 38 through a pin. The other end of the link 39 is attached to one point on a space through another pin to be swingable, and a shaft portion 40 is formed by the pin on the right side and a shaft hole of the link 39.

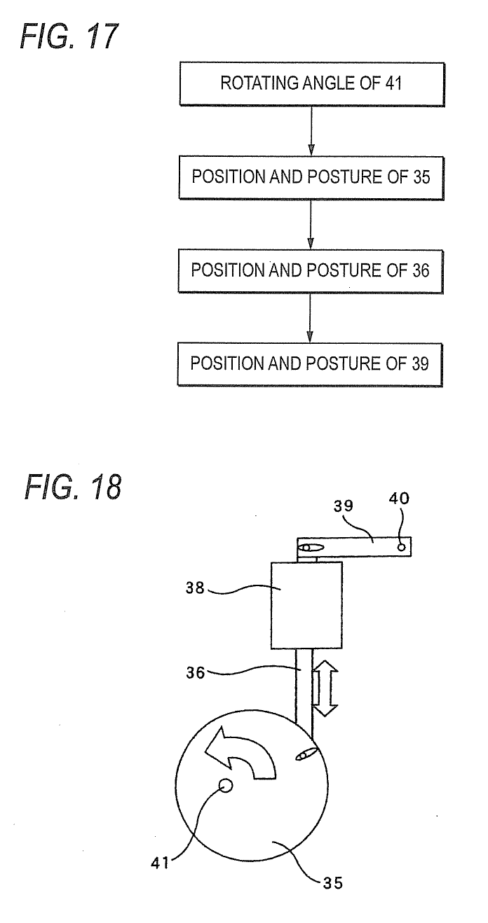

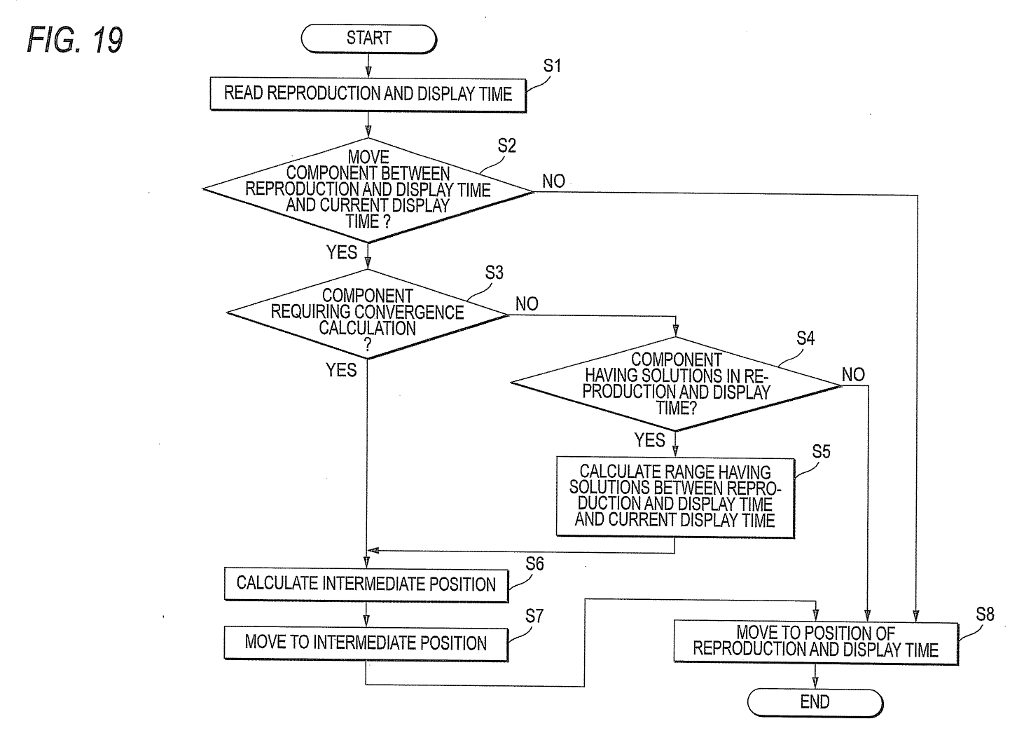

When a rotating angle of a cam eccentric shaft 41 is determined, positions of the components to be the cam 35, the follower 36 and the link 39 are sequentially determined. FIG. 17 shows their relationship. FIG. 17 is a drawing for explaining order for determining the positions of the components. When the rotating angle of the motor shaft (that is, the rotating angle of the cam eccentric shaft 41) is determined, the position of the component (cam) 35 connected directly to the motor shaft is determined. When the position of the component 35 is determined, the position of the component (follower) 36 is determined through the convergence calculation and the position of the component (link) 39 is then determined. In order to calculate the position of the component 36, it is necessary to perform the convergence calculation. Therefore, it is necessary to execute the convergence calculation for calculating the position of the component 36 in order to determine the position of the component 39 requiring the result. By thus tracing the order for determining the position of the component as shown in FIG. 17, the simulation reproducing apparatus knows that the component 39 requires the convergence calculation for determining the position. The analysis is performed in the geometric constraint module 62. At a determining step S3 in a flowchart of FIG. 19 which will be described below, the component such as the component 39 is determined to require the convergence calculation. In the case in which the components 35 and 36 are coupled to each other through a pin as in FIG. 18, the position of the component 36 is determined when the position of the component 35 is determined. In this case, it is possible to perform the calculation for obtaining the position by solving the algebraic equation as in the case described with reference to FIGS. 10 to 12. Therefore, neither the component 36 nor the component 39 require the convergence calculation.

Next, description will be given to a process procedure in the case in which the simulation reproducing apparatus according to the embodiment performs the reproduction and display. The variable history storing module 57 shown in FIG. 2 stores an input value and presence of the movement of the component from the hybrid model simulation module 56 to the mechanism (kinematics) simulation module 58 at all time steps in the simulation.

The variable history storing module 57 stores two types of flags. A first flag indicates whether a solution can be obtained by the convergence calculation for the component or not. A second flag indicates whether at least two solutions are obtained or not. The second flag is obtained as a result of a calculation performed as to whether at least two solutions are obtained every time step in the execution of the simulation in addition to the information for the component of which solution can be obtained irrespective of the convergence calculation and which is registered in the movement monitoring target component DB 64.

When the simulation reproduction is to be performed, a last reproduced and displayed status is displayed on the display device 67 shown in FIG. 3. If the same status is set to be obtained before the reproduction and display, a simulation time corresponding to the status is stored in the current display time storing module 68. The user designates the reproduction and display in the form of a simulation time to be reproduced and displayed through the input device 69. The input data are transmitted to the intermediate position determination module 66, and the intermediate position determination module 66 determines whether an intermediate position is to be calculated in a movement from a current display time to a reproduction and display time by referring to the reproduction and display time and data in the current display time storing module 68. If the intermediate position determination module 66 determines that the intermediate position is to be calculated, it starts the geometric constraint module 62 to calculate a position and a posture of an assembly corresponding to the intermediate position and stores a result of the position and the posture in the assembly model storing module 61. The intermediate position determination module 66 causes the geometric constraint module 62 to calculate the intermediate position at a necessary number of times and then starts the geometric constraint module 62 with a variable value corresponding to a reproduction and display time, calculates the position and posture of the assembly, and further starts the assembly model storing module 61 and causes the display device 67 to perform a three-dimensional CG display. When the display device 67 performs a display, the reproduction and display time is stored as a value of the current display time in the current display time storing module 68.

FIG. 19 is a flowchart showing a process for determining whether the intermediate position determination module 66 is to calculate the intermediate position. At step S1, a reproduction and display time is read. At a determining step S2, the intermediate position determination module 66 determines whether a component noted by a user is moved between a reproduction and display time and a current display time or not. If it is determined that the component is not moved, the process passes through an NO route and a display is preferably performed exactly after a process of step S8. In the display process, a component which is not noted by the user might be moved. Therefore, it is preferable to once start the geometric constraint module 62. If it is determined that the component is moved at the step S2, the process passes through a YES route and it is determined whether a component requiring a convergence calculation is present or not at a determining step S3. If the intermediate position determination module 66 determines that the component requiring the convergence calculation such as a cam is present at the step S3, the process passes through a YES route and the intermediate position determination module 66 sets an intermediate position at a predetermined interval between the reproduction and display time and the current display time (step S6). At step S7, a movement to the intermediate position is performed and a simulation is thus executed.

If it is determined that the component requiring the convergence calculation is not present at the step S3, the process passes through an NO route to step S4 of making a determination. In this case, the intermediate position determination module 66 determines whether each of a position and a posture of the component has a plurality of solutions or not at a reproduction and display time. If it is determined that the component has the solutions, the process passes through a YES route and the intermediate position determination module 66 performs a calculation within a range in which the solutions are present between the reproduction and display time and the current display time at step S5, and the intermediate position is set at the predetermined interval within the range at the step S6. If it is determined that the component does not have the solutions at the step S4, the process passes through an NO route so that the process of the step S8 is executed.

The simulation reproducing apparatus is configured to calculate whether at least two solutions are present for every time step in the simulation or not in the execution of the simulation and to store a flag indicative of a result of the presence of the solutions every time step in the variable history storing module 57. However, the simulation reproducing apparatus according to the embodiment may start the geometric constraint module 62 to determine whether at least two solutions are present or not by using the geometric constraint module 62 when performing the reproduction and display.

The description has been given to the representation and simulation of the assembly model such as a robot. Next, a characteristic representation of a motor will be described. In modeling of an actuator such as the motor, a behavior taken on a time base such as acceleration or deceleration is important and a representation of dynamics is required.

The simulation reproducing apparatus according to the embodiment employs a method of representing a system as an ordinary differential simultaneous equation through a hybrid modeling language. A specific fine specification and basic thinking manner of the hybrid modeling language has been described in detail in the related-art document 1, which was partly written by the inventor of the present invention.

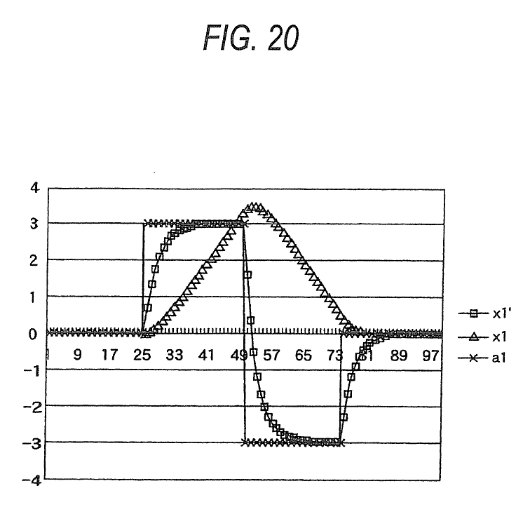

FIG. 20 shows an example of a simple DC motor model and an example of a result of an operation thereof.

X1″=b1(a1−x1′)

b1=6.0

a1=3.0

a1=−3.0

a1=0.0

x1 represents a rotating angle of a motor, b1 represents a parameter for defining a sharpness of a rise, and a1 represents a stationary rotating speed. Three expressions shown above related to a1 are switched depending on a normal rotating mode, a reverse rotating mode or a stopping mode of the motor.

With an increase in the rotating speed, a back electromotive force is generated on a coil. A current flowing to the motor is decreased by the back electromotive force. Therefore, on the assumption that acceleration is reduced and a rotation is performed at a constant speed, the system is modeled and the differential equation is obtained.

Examples of other known languages describing the hybrid system include a Hybrid Concurrent Constraint Programming language (HCC) which is studied in the Palo Alto Research Center of Xerox Co., Ltd., United States of America, and is developed and researched in the NASA Ames Institute, United States of America. This is one type of technique which is referred to as constraint programming. A differential equation and an algebraic equation, which represent a model, are supposed to be constraints and are exactly described in random order. A program for controlling a status transition is added to them so that a model is finished. It is convenient that the equations can be exactly listed as the constraints to make a program. However, this is a kind of programming language and can describe a complicated model. However, it is necessary to understand the constraint programming and the program language is abstruse. For this reason, it is hard to acquire a programming ability for this language.

The Matlab (registered trademark) product group manufactured by MathWorks Co., Ltd. is a software tool which is often used mainly by control engineers and can equivalently describe a model represented by a hybrid model. However, a differential equation cannot be exactly described in a continuous system, for example, and is to be defined again as a block drawing in which the contents of the differential equation are analyzed to combine elements such as integral elements.

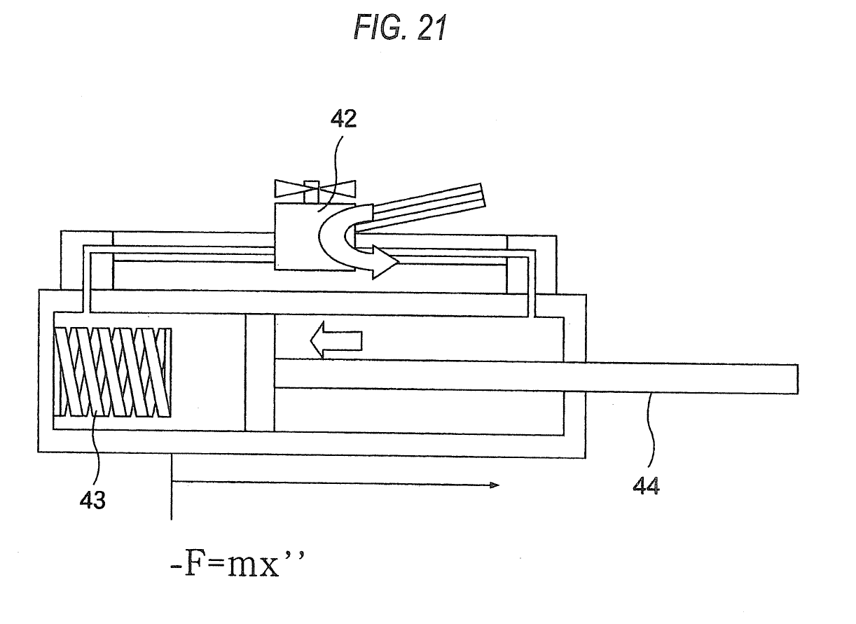

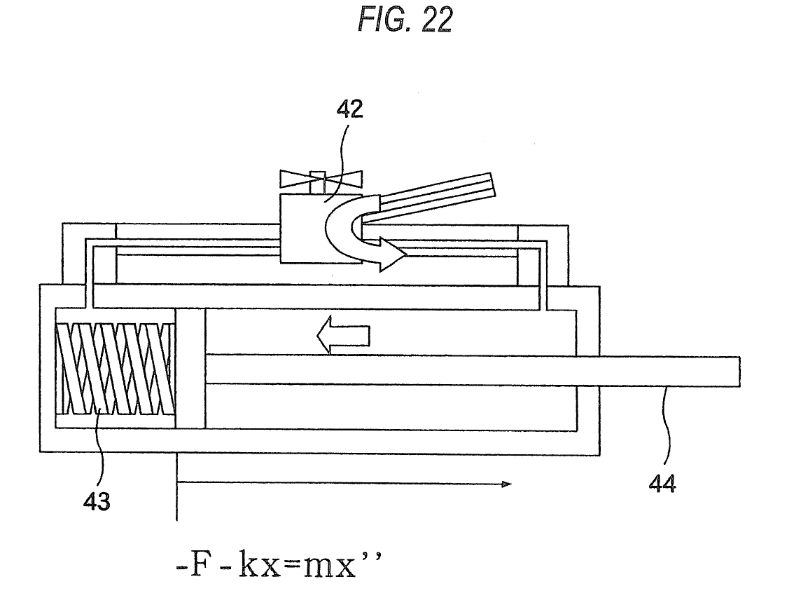

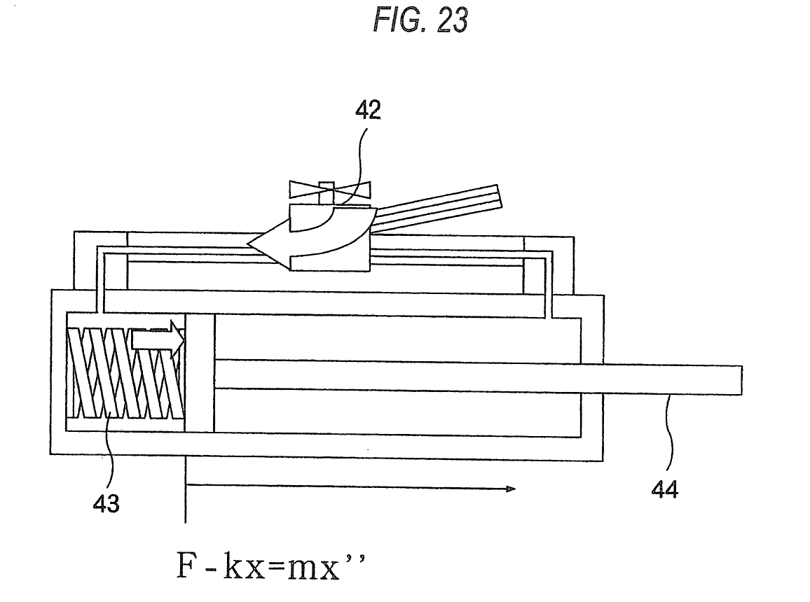

By taking a specific example, description will be given to how to input a hybrid model and to output a result through the simulation reproducing apparatus according to the embodiment. First of all, a simple example will be described with reference to FIGS. 21 to 25. The elements shown in FIGS. 21 to 25 which have the same reference numerals as described above represent the same portions.

A mechanical apparatus shown in FIG. 21 is a model of a pneumatic actuator mechanism including a valve 42, a spring 43 and a piston 44. A vent hole for causing an inside to communicate with an outside of an air cylinder is formed in two portions on left and right parts at a side surface of an air cylinder. The valve 42 provided on an air cylinder body has a structure in which compressed air is sucked with switching into left and right air courses and can change a position for an air flow to a right side (hereinafter referred to as Right) or a left side (hereinafter referred to as Left) in accordance with a command sent from an outside. In FIG. 21, the valve 42 is brought into a status of Right. Therefore, a leftward force is applied to the piston 44. An equation of motion indicative of the status is expressed in the following expression (which is also shown below the piston 44 in FIG. 21).

−F=mx″

FIG. 22 shows a status in which the piston 44 is further moved leftward and a pressure plate attached to a tip of the piston 44 abuts on the spring 43. In this status, a reactive force is generated by the spring 43. Therefore, the equation of motion is changed as shown in FIG. 22.

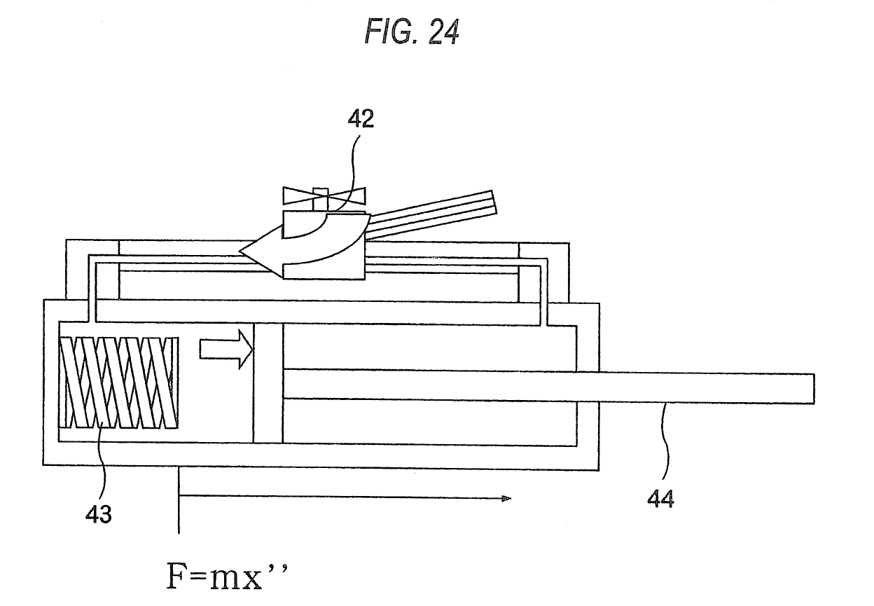

In FIG. 23, the position of the valve 42 is brought into a status of Left so that a direction of the air flow is changed and the equation of motion is further varied. In FIG. 24, the piston 44 is moved and the reactive force from the spring 43 is eliminated, and the equation of motion is further varied.

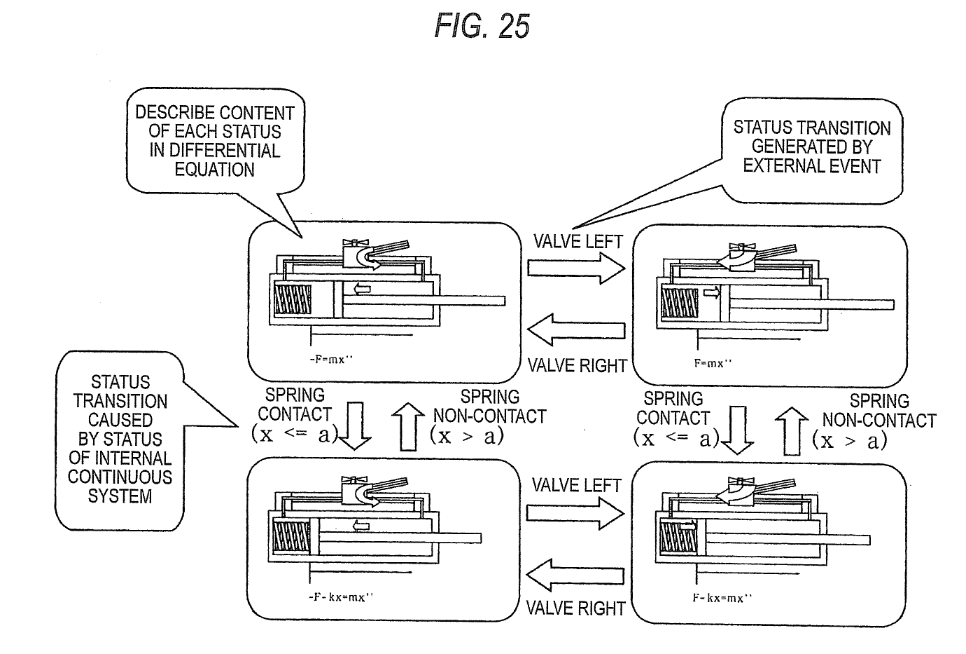

FIG. 25 represents, as a status transition view, the change of the status and the equation of motion corresponding to each status. A hybrid model indicates a status transition and a description of each status which is expressed in a differential equation or an algebraic equation as shown in FIG. 25.

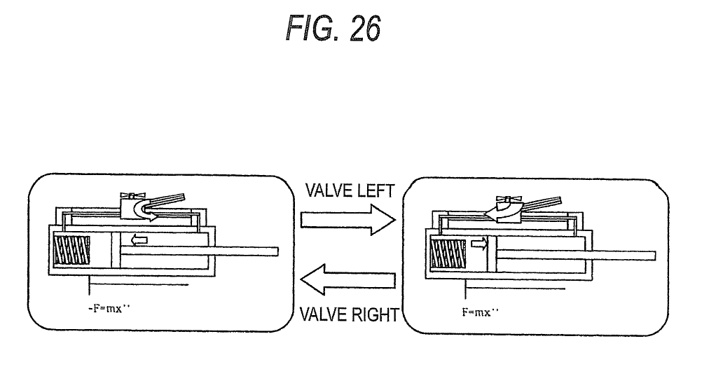

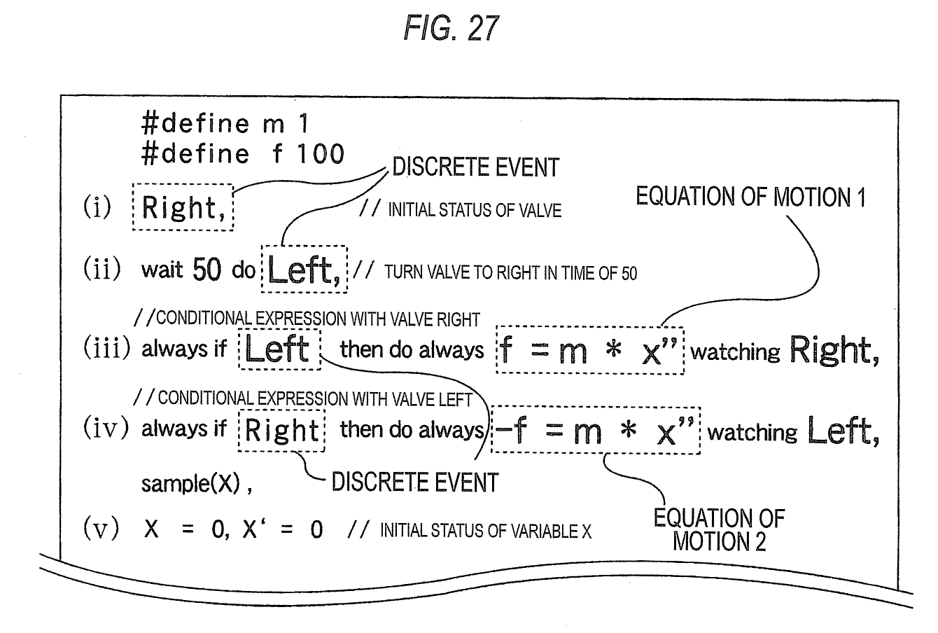

FIG. 26 is obtained by further simplifying the example of FIG. 25 in order to explain how to output the input data to the description of the model for easy understanding as the status transition view. Two states and a status transition between the states will be supposed. FIG. 27 shows an example in which the contents of the model in FIG. 26 are described in HCC. (i), (ii) and (v) in FIG. 27 describe operating conditions such as an initial status of a mechanical apparatus and a valve manipulation timing, and (iii) and (iv) in FIG. 27 represent the status transition of FIG. 26. In the HCC, the equation of motion can be exactly written. It is preferable to describe a condition for a transition to each status after first “always if” and a condition for a transition from each status after last “watching”.

In a hybrid constraint programming language, a program is not executed in describing order (order in (i) to (v) in FIG. 27). Individual program descriptions which are established are searched and executed along a time base for performing the simulation. Therefore, the order of (i) to (v) is not restricted. For example, when the simulation is started, only (i) and (v) are valid. Event Right is generated through (i) at time of start. Therefore, Right to be a precondition of (iv) is valid and an equation of motion 2 in (iv) is valid, and the simulation is executed in a status on the left side of FIG. 26. When a time reaches 50, (ii) is valid, event Left is generated, a transition condition of (iv) (watching and the following) is valid, and the equation of motion of (iv) is invalid. Instead, a precondition of (iii) is valid and an equation of motion 1 is valid.

By implementing the hybrid model simulation module 56 in FIG. 2 as described above, it is possible to implement the mechanism simulator 53 for performing a simulation of the mechanism to be the control target.

As described above, according to the simulation reproducing apparatus and the simulation reproducing and displaying method according to the embodiment, it is possible to lessen an amount of the calculation and to efficiently process the situation of the control target at an optional time point after the execution of the simulation when setting the mechatronics apparatus as a target to verify the control program by using the simulator in place of the actual mechanism to be the control target. Thus, it is possible to display the result of the simulation at a high speed.

In the case in which the simulation is completed and the situation in the simulation is then reproduced and displayed by the simulator, the simulator traces a result of the execution, displays a mechanical operation three-dimensionally and reproduces and performs the mechanical operation, or generates a timing chart. A user selects an optional time point displayed on a screen and verifies a position and a posture of an assembly in a space at the selected point. According to the simulation reproducing apparatus according to the embodiment, it is instantly determined whether the equation has one solution or at least two solutions. If it is determined that the equation has one solution, it is possible to jump to a time selected by the user and to calculate and display the position and posture of the mechanism at that point. Referring to a time region in which a plurality of solutions is present, the simulation reproducing apparatus inserts a range of a time to be recalculated and the recalculation is performed at each point within a range of the time. Consequently, it is possible to prevent a mechanism in an erroneous position or a mechanism taking an erroneous posture from being output as a result of the recalculation. Consequently, it is possible to reproduce and display the correct position and posture of the mechanism and to increase a speed of the recalculation.

In one simulation, the number of times for sampling is several thousands to several ten thousands. In the case in which one solution is present, the simulation reproducing apparatus according to the embodiment can jump to a point selected by a user and can perform a simulation for that point, thereby reproducing and displaying a result. In the case in which a plurality of solutions is present, the simulation reproducing apparatus can perform a reproduction and a display for any of numerous points which is selected without performing a process for operating the mechanism in order of a time history of a result of the calculation at each point or skipping some time intervals for performing the simulation to operate the mechanism. Accordingly, it is possible to lessen the amount of the calculation and to efficiently execute the process when recalculating the position and posture of the mechanism. It is possible to rapidly display the result of the simulation at an optional time point.

The invention is not exactly restricted to the embodiment but the components can be deformed and embodied without departing from the scope in an performing stage. Although all of the components constituting the mechanism are displayed on the screen in FIGS. 10 to 12, the simulation reproducing apparatus according to the embodiment can also prevent any of the components from being displayed. For example, in some cases in which a position and a posture of a certain component are to be confirmed, a visual line from a forward part for the component at a rear side is blocked because another component is positioned before the certain component. The simulation reproducing apparatus can also add the function for concealing unnecessary components for the convergence calculation from the screen. When the user performs an operation for preventing the rod 32, the slider 33 and the rail 34 from being displayed, it is possible to verify only the disk 31 of which position is determined by only the rotating angle of the motor shaft.

It is also possible to store a simulation program for causing a computer to execute the simulation reproducing and displaying method according to the embodiment. The computer reads the program, thereby functioning as the simulation reproducing apparatus according to the embodiment. The simulation program according to the embodiment is stored in various hard disk or computer readable storage media and can be thus saved, transported and sold easily.

By a proper combination of the components disclosed in the embodiment, it is possible to form various inventions. For example, some of all the components described in the embodiment may be deleted.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A simulation reproducing apparatus that performs a simulation for verifying a control program for controlling a target mechanism of a mechatronics apparatus by simulating a behavior of the target mechanism in cooperation with the control program, the apparatus comprising:
a hybrid model simulator that reads out hybrid model data describing a motion of a movable component included in the target mechanism and performs a dynamics simulation while reading a control command output from the control program for every cycle time during the dynamics simulation;
an assembly model storing module that reads out mechanism model data and stores assembly model data for an assembly model represented by geometric features of components included in the target mechanism and by constraints between the components;
a geometric constraint module that performs a geometric constraint process by referring to the assembly model data;
a movement monitoring module that monitors the geometric constraint module to detect a movement of the components;
a variable history storing module that stores data input to the geometric constraint module from the hybrid model simulator for every cycle time and a result of movement detected by the movement monitoring module; and
an intermediate position determination module that calculates an intermediate position on which the geometric constraint module is to be started by referring to a current display time point and a desired simulation time point, the current display time point being currently displayed after completion of the simulation, the desired simulation time point being input after completion of the simulation for reproducing the result of the simulation thereat,
wherein the geometric constraint module is started based on the intermediate position calculated by the intermediate position determination module to output the result of the geometric constraint process re-performed based on the intermediate position.

2. The apparatus according to claim 1 further comprising a display device that displays the result of the simulation.

3. The apparatus according to claim 1, wherein the intermediate position determination module calculates whether more than one solutions exist for either one of a position and a posture for each components during the simulation, and
wherein the variable history storing module stores a flag that indicates whether more than one solutions exist calculated by the intermediate position determination module.

4. The apparatus according to claim 1, wherein the intermediate position determination module switches a method for calculating the intermediate position for a first case in which a solution for a position and a posture of at least one of the components is required to be obtained through a convergence calculation, and for a second case in which a solution for a position and a posture of every one of the components is obtainable by solving an algebraic equation.

5. A method for performing a simulation for verifying a control program for controlling a target mechanism of a mechatronics apparatus by simulating a behavior of the target mechanism in cooperation with the control program, the method comprising:
performing a simulation including a dynamics simulation and a kinematics simulation over a given cycle times, the dynamics simulation being performed by a hybrid model simulation module for performing the dynamics simulation by using a hybrid model describing a motion of a movable component included in the target mechanism, the kinematics simulation being performed by a kinematics simulation module for performing the kinematics simulation by using an assembly model represented by geometric features of components included in the target mechanism and by constraints between the components;
reading out a desired simulation time point at which the result of the simulation is to be reproduced;
fetching a current time point being currently displayed after completion of the simulation;
calculating an intermediate position on which a geometric constraint process is to be performed based on the desired simulation time point and the current time point;
re-performing the kinematics simulation including the geometric constraint process on the intermediate position by the kinematics simulation module; and
outputting the result of the simulation at the desired simulation time point.

6. A computer readable medium storing a program causing a computer to execute a process for performing a simulation for verifying a control program for controlling a target mechanism of a mechatronics apparatus by simulating a behavior of the target mechanism in cooperation with the control program, the process comprising:
performing a simulation including a dynamics simulation and a kinematics simulation over a given cycle times, the dynamics simulation being performed by a hybrid model simulation module for performing the dynamics simulation by using a hybrid model describing a motion of a movable component included in the target mechanism, the kinematics simulation being performed by a kinematics simulation module for performing the kinematics simulation by using an assembly model represented by geometric features of components included in the target mechanism and by constraints between the components;
reading out a desired simulation time point at which the result of the simulation is to be reproduced;
fetching a current time point being currently displayed after completion of the simulation;
calculating an intermediate position on which a geometric constraint process is to be performed based on the desired simulation time point and the current time point;
re-performing the kinematics simulation including the geometric constraint process on the intermediate position by the kinematics simulation module; and
outputting the result of the simulation at the desired simulation time point.

7. A simulation reproducing apparatus that performs a simulation for verifying a control program for controlling a target mechanism of a mechatronics apparatus by simulating a behavior of the target mechanism in cooperation with the control program, the apparatus comprising:
a memory that stores data; and
a processor that operates in cooperation with the memory to:
perform a simulation including a dynamics simulation and a kinematics simulation over a given cycle times, the dynamics simulation being performed by a hybrid model simulation module for performing the dynamics simulation by using a hybrid model describing a motion of a movable component included in the target mechanism, the kinematics simulation being performed by a kinematics simulation module for performing the kinematics simulation by using an assembly model represented by geometric features of components included in the target mechanism and by constraints between the components;
read out a desired simulation time point at which the result of the simulation is to be reproduced;
fetch a current time point being currently displayed after completion of the simulation;
calculate an intermediate position on which a geometric constraint process is to be performed based on the desired simulation time point and the current time point;
re-perform the kinematics simulation including the geometric constraint process on the intermediate position by the kinematics simulation module; and
output the result of the simulation at the desired simulation time point.

8. A simulation reproducing apparatus that performs a simulation for verifying a control program for controlling a target mechanism of a mechatronics apparatus by simulating a behavior of the target mechanism in cooperation with the control program, the apparatus comprising:
a hybrid model simulation means for reading out hybrid model data describing a motion of a movable component included in the target mechanism and performing a dynamics simulation while reading a control command output from the control program for every cycle time during the dynamics simulation;
an assembly model storing means for reading out mechanism model data and storing assembly model data for an assembly model represented by geometric features of components included in the target mechanism and by constraints between the components;
a geometric constraint means for performing a geometric constraint process by referring to the assembly model data;
a movement monitoring means for monitoring the geometric constraint means to detect a movement of the components;
a variable history storing means for storing data input to the geometric constraint means from the hybrid model simulation means for every cycle time and a result of movement detected by the movement monitoring means; and
an intermediate position determination means for calculating an intermediate position on which the geometric constraint means is to be started by referring to a current display time point and a desired simulation time point, the current display time point being currently displayed after completion of the simulation, the desired simulation time point being input after completion of the simulation for reproducing the result of the simulation thereat,
wherein the geometric constraint means is started based on the intermediate position calculated by the intermediate position determination means to output the result of the geometric constraint process re-performed based on the intermediate position.
